(19) United States
(12) Patent Application Publication
(10) Pub. No.: US 2009/0017872 A1
(43) Pub. Date: Jan. 15, 2009

(54) DISPLAY SYSTEM FOR PORTABLE ELECTRONIC DEVICES WITH RELATED SUB-DISPLAYS

(76) Inventors: Larry David Myers, Durham, NC (US); Richard Kevin Sawyer, Durham, NC (US); Elliott Hsu, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/776,032

(22) Filed: Jul. 11, 2007

(51) Int. Cl. H04B 1/38

(52) U.S. Cl. 455/566

(57) ABSTRACT

A display system for an electronic device includes a first sub-display and a second sub-display in signal communication with the first sub-display. The sub-displays together may display related information within a given category, such as time, weather, messages, etc. The display system also may include a navigation mechanism that permits the user to navigate through and select data items from at least one of the first or second sub-displays. In response to a data selection, at least one of the sub-displays alters its view such that the sub-displays together may display a new dataset of related information within the given category. The navigation mechanism also may be used to toggle through various additional categories of information. In an exemplary embodiment, the display system may be the external display of a clamshell mobile telephone in the closed position.

### TECHNICAL FIELD OF THE INVENTION

The technology of the present disclosure relates generally to multiple displays on a portable electronic device such as a mobile telephone, and more particularly to a display system having a first sub-display and a second sub-display that together display datasets of related information.

### DESCRIPTION OF THE RELATED ART

Display systems of current portable electronic devices simply are inadequate to display a large quantity of information in a user friendly form.

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

The more information a device processes, however, the more difficult it becomes to display pertinent information in a manner that is meaningful and user friendly. One solution has been to provide a more detailed single display, but a single display is limited in that it can become too cluttered as more information is added. Conventional “block” or “brick” style mobile telephones, as well as slide-cover type mobile telephones, tend to have such a single display.

Another alternative is to provide multiple displays. For example, a conventional “clamshell” mobile telephone with a flip-open cover often is configured to have two displays, an internal display visible when the telephone is open, and an external display visible when the telephone is closed. When the telephone is open, a user has access to the keypad and other navigation or input devices as may be present. Many aspects of the functionality of the mobile telephone are displayed on the internal display. When the clamshell is closed, many features of the mobile telephone may be unusable because the keypad and other navigation/input devices are not accessible. The information displayed on the external display, therefore, tends to be scant, limited to such items as time, date, signal strength, remaining battery power, and the like. To obtain a display of more detailed information, including information associated with non-telephone features such as multimedia and Internet capabilities, one must open the clamshell. Opening the clamshell may be an unnecessary inconvenience for situations when the user wants to quickly access a useful subset of the mobile telephone functionality.

Another disadvantage of the typical clamshell mobile telephone is that the internal and external displays are not substantially linked to one another. They therefore tend to act as two distinct single displays, and thus suffer the same limitations as any single display.

### SUMMARY

To improve the consumer experience with portable electronic devices, there is a need in the art for an improved display system. The display system of the present invention includes a first sub-display and a second sub-display in signal communication with the first sub-display. The sub-displays together may display related information within a given category, such as time, weather, messages, etc. The display system also may include a navigation mechanism that permits the user to navigate through and select data items from at least one of the first and second sub-displays. In response to a data selection, at least one of the sub-displays alters its view such that the sub-displays together may display a new dataset of related information within the given category. The navigation mechanism also may be used to toggle through various additional categories of information. In an exemplary embodiment, the display system is the external display of a clamshell mobile telephone in the closed position.

Therefore, according to one aspect of the invention, an electronic device includes a display system having a first sub-display and a second sub-display, wherein the first and second sub-displays together display a first dataset of related information, a navigation mechanism, and a controller that is configured to receive an input from the navigation mechanism corresponding to a data selection from at least one of the first or second sub-displays, wherein in response to the input, the controller alters the view of at least one of the first or second sub-displays such that the sub-displays together display a second dataset of related information.

According to one embodiment of the electronic device, the electronic device is a mobile telephone.

According to one embodiment of the electronic device, the mobile telephone is a clamshell mobile telephone with a flip-open cover movable between an open and a closed position, and the first sub-display, second sub-display, and navigation mechanism are located on an external surface of the mobile telephone when the mobile telephone is in the closed position.

According to one embodiment of the electronic device, at least part of the navigation mechanism is integrated with the second sub-display.

According to one embodiment of the electronic device, the navigation mechanism comprises a touchpad.

According to one embodiment of the electronic device, the touchpad is a five-way touchpad comprising four directional touchpad surfaces and a fifth enter button.

According to one embodiment of the electronic device, the navigation mechanism further comprises a toggle button.

According to one embodiment of the electronic device, the related information is a first category of information, and the controller is further configured to receive an input from the toggle button and in response to the toggle button input, the controller alters the view of at least one of the first or second sub-displays such that the sub-displays together display a dataset relating to a second category of information.

According to one embodiment of the electronic device, the related information is defined by a matrix stored in a memory within the electronic device, and the matrix is displayed on at least one of the first or second sub-displays.

According to one embodiment of the electronic device, the first sub-display displays a general aspect of the related information and the second sub-display displays a specific aspect of the related information.

According to another aspect of the invention, a display system includes a first sub-display, a second sub-display in signal communication with the first sub-display, wherein the first and second sub-displays together display a first dataset of related information, and a navigation mechanism configured to make a data selection from at least one of the first or second sub-displays, wherein a selection with the navigation mechanism from at least one of the first or second sub-displays alters the view of at least one of the first or second sub-displays, such that the first and second sub-displays together display a second dataset of related information.

According to one embodiment of the display system, at least part of the navigation mechanism is integrated with the second sub-display.

According to one embodiment of the display system, the navigation mechanism comprises a touchpad.

According to one embodiment of the display system, the touchpad is a five-way touchpad comprising four directional touchpad surfaces and a fifth enter button.

According to one embodiment of the display system, the navigation mechanism further comprises a toggle button.

According to one embodiment of the display system, the related information is defined by a matrix displayed on at least one of the first or second sub-displays.

According to one embodiment of the display system, the first sub-display displays a general aspect of the related information and the second sub-display displays a specific aspect of the related information.

According to another aspect of the invention, a method of displaying information on an electronic device includes the steps of displaying a dataset portion on a first sub-display, displaying another dataset portion on a second sub-display wherein the dataset portions together comprise a first dataset of related information, navigating through at least one of the dataset portions on at least one of the first or second sub-displays, selecting a data item from at least one of the dataset portions on at least one off the first or second sub-displays, and altering the view displayed on at least one of the first or second sub-displays in response to the selection such that the sub-displays together display a second dataset of related information.

According to one embodiment of the method, the related information is a first category of information, and the method further includes toggling the first and second sub-displays such that the sub-displays together display a dataset relating to a second category of information.

According to one embodiment of the method, the related information is a first category of information, and the method includes navigating through an information matrix of data items displayed on at least one of the first or second sub-displays, selecting a data item from the matrix, and altering at least one of the first or second sub-displays such that the sub-displays together display a dataset relating to a second category of information.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of the front external surface of a clamshell mobile telephone in the closed position as an exemplary electronic device for use in accordance with an embodiment of the present invention.

FIGS. 2A-C depict exemplary uses of a display system in accordance with an embodiment of the present invention with the mobile telephone of FIG. 1.

FIG. 3 depicts an exemplary widget matrix for use in accordance with an embodiment of the present invention.

FIGS. 4A-H depict additional exemplary uses of a display system in accordance with an embodiment of the present invention with the mobile telephone of FIG. 1.

FIG. 5 is a schematic front view of the mobile telephone of FIG. 1 with the clamshell in the open position.

FIG. 6 is a schematic block diagram of operative portions of the mobile telephone of FIG. 1.

FIG. 7 is a schematic diagram of a communications system in which the mobile telephone of FIG. 1 may operate.

FIG. 8 is a flowchart depicting an exemplary method that may be used in accordance with an embodiment of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The following description is made in the context of a conventional clamshell mobile telephone with a flip cover that may be moved between an open and a closed position. It will be appreciated that the invention is not intended to be limited to the context of a mobile telephone and may relate to any type of appropriate electronic equipment, examples of which include a media player, a gaming device, or a computer. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any portable communication apparatus or the like.

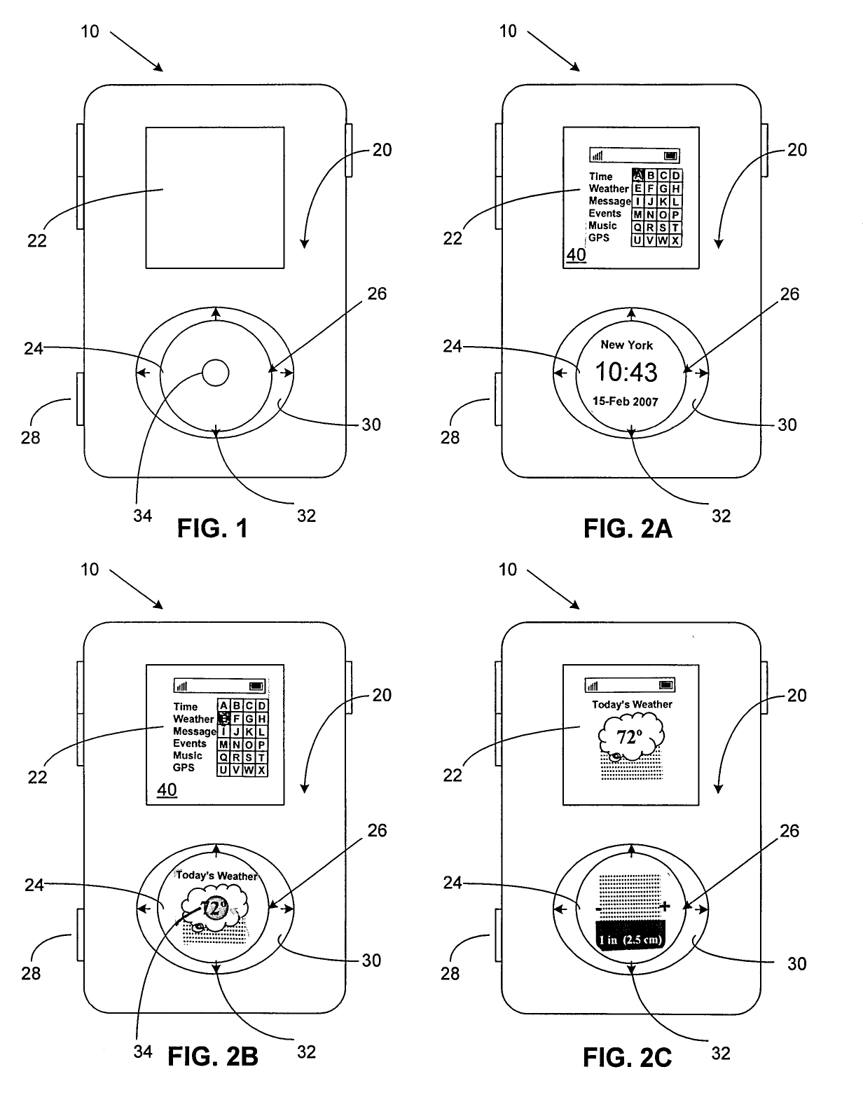

Referring initially to FIG. 1, a mobile telephone 10 is shown as a clamshell-type telephone in the closed position. This particular view is of the front external surface of the mobile telephone 10. The mobile telephone contains a display system 20 on the external front surface of the closed clamshell. Display system 20 includes a first sub-display 22 and a second sub-display 24. Display system 20 also includes a navigation mechanism 26. In an exemplary embodiment, the navigation mechanism may include a toggle button 28 and a five-way touchpad 30. Sub-displays 22, 24 are in signal communication with one another such that the information displayed on the sub-displays are related or linked. In one embodiment, first sub-display 22 may display a general aspect of the related information, and second sub-display 24 may display a more specific aspect of the related information.

In an exemplary embodiment, the five-way touchpad may be integrated with the second sub-display 24 such that one touches the screen of the second sub-display to navigate with the touchpad. In an alternative embodiment, the five-way touchpad 30 may be separate ring that at least in part may circumscribe the second sub-display. The touchpad may include four directional surfaces 32 for navigating up and down, and side to side (previous and next), through text or iconic menus, or other selectable options and data items displayed on either of the sub-displays. In one embodiment, the four directional surfaces may be indicated as directional arrows. The touchpad further may include a fifth central button 34 that acts as an enter button for inputting a selection. It will be appreciated that central button 34 may be covered by the content of the second sub-display. Though not fully visible, the central button is present and usable (see, e.g., shaded region in FIG. 2B). For clarity, the central button 34 is not shown in all the figures, although present. Toggle button 28 may provide additional navigational features, as further described below.

Other navigation and input mechanisms may be employed. For example, the navigation mechanism may include a scroll wheel instead of directional surfaces, or the navigation mechanism may be a second keypad comparable to the keypad associated with the internal display of the clamshell telephone. Alternatively, the second sub-display 24 may act as a touch screen for navigating through selectable items.

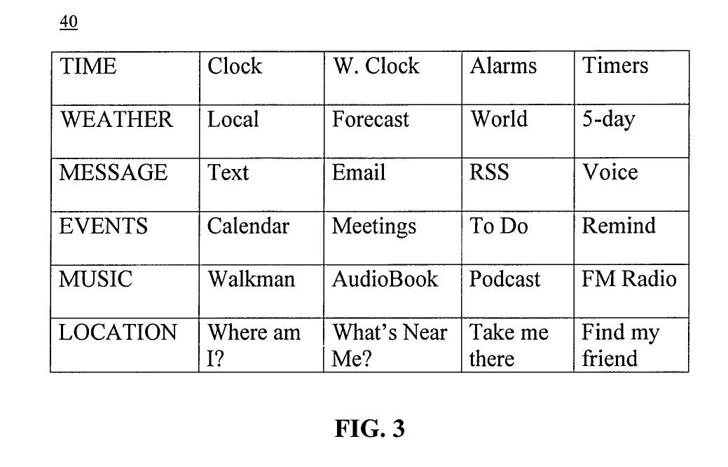

Referring now to FIGS. 2A-C and 3, FIG. 2A depicts an exemplary initial configuration of the display system 20. First sub-display 22 contains a menu of functional or informational categories generally referred to in the industry as “widgets”. In this example, the widget categories of information include Time, Weather, Message, etc., although other exemplary widgets may be included. The various widget categories may be organized into datasets arranged in a widget matrix 40, which may be a text or iconic menu navigated using the touchpad 30. Navigating down the matrix alters the widget category while navigating across the matrix accesses various widget datasets. In this example, as shown in FIGS. 2A and 2B, the widget datasets may simply be designated by letters in the widget matrix to save space. In alternative embodiments, the widget matrix may contain icons, or text descriptions such as those shown in FIG. 3. The highlighted item in the widget matrix may be displayed on the second sub-display 24. In FIG. 2A, for example, the first dataset for the time widget is highlighted, and the local date and time are displayed in sub-display 24.

FIGS. 2A-C illustrate how navigation through the widget matrix 40 may be performed. In FIG. 2B, the user has navigated from the time widget (FIG. 2A) to the weather widget using the directional surfaces 32 on touchpad 30. Second sub-display 24 now displays current weather information. Should the user desire additional weather information, the user may enter the weather widget by pressing the central button 34 on touchpad 30, which in this example results in the display depicted in FIG. 2C. Now, the current weather conditions are displayed in the first sub-display 22, and additional weather information may be displayed in the second sub-display 24. In FIG. 2C, the second sub-display graphically depicts recent precipitation history. Using the touchpad, the user may navigate through different weather information datasets, which is tantamount to navigating horizontally in the widget matrix. For example, an alternative dataset may contain different historical weather information in the second sub-display, such as recent temperature or pressure trends. In another dataset, the second sub-display may contain forecast information for one or more upcoming days.

Once within a particular widget category, such as time or weather, toggle button 28 may provide additional navigation features. For example, a single press may navigate forward to the next widget category in the widget matrix, and a quick double press may navigate to the previous widget category. In this manner, a user may jump from widget category to category without having to return to the initial widget matrix screen. In addition, a press-and-hold of the toggle button may return the display to the initial widget matrix screen should the user so desire. Alternatively, the arrows of the touchpad surface may be used to navigate from one widget category to the next or previous.

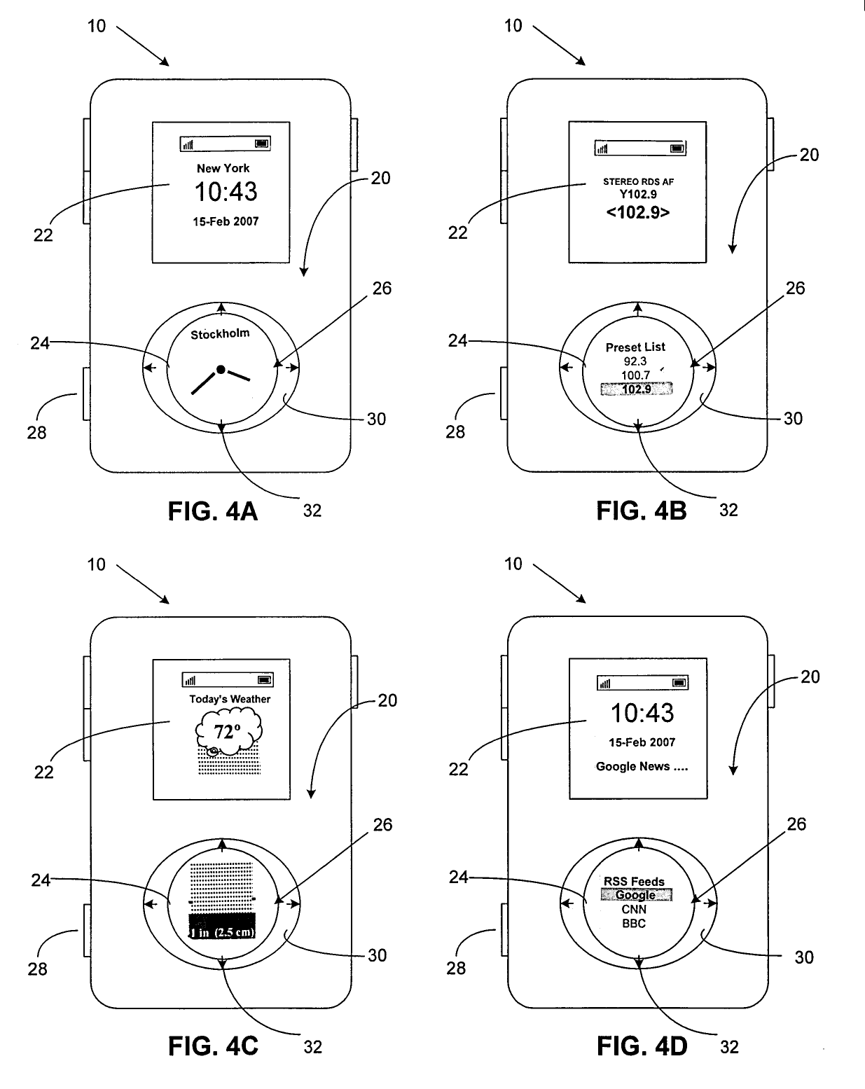

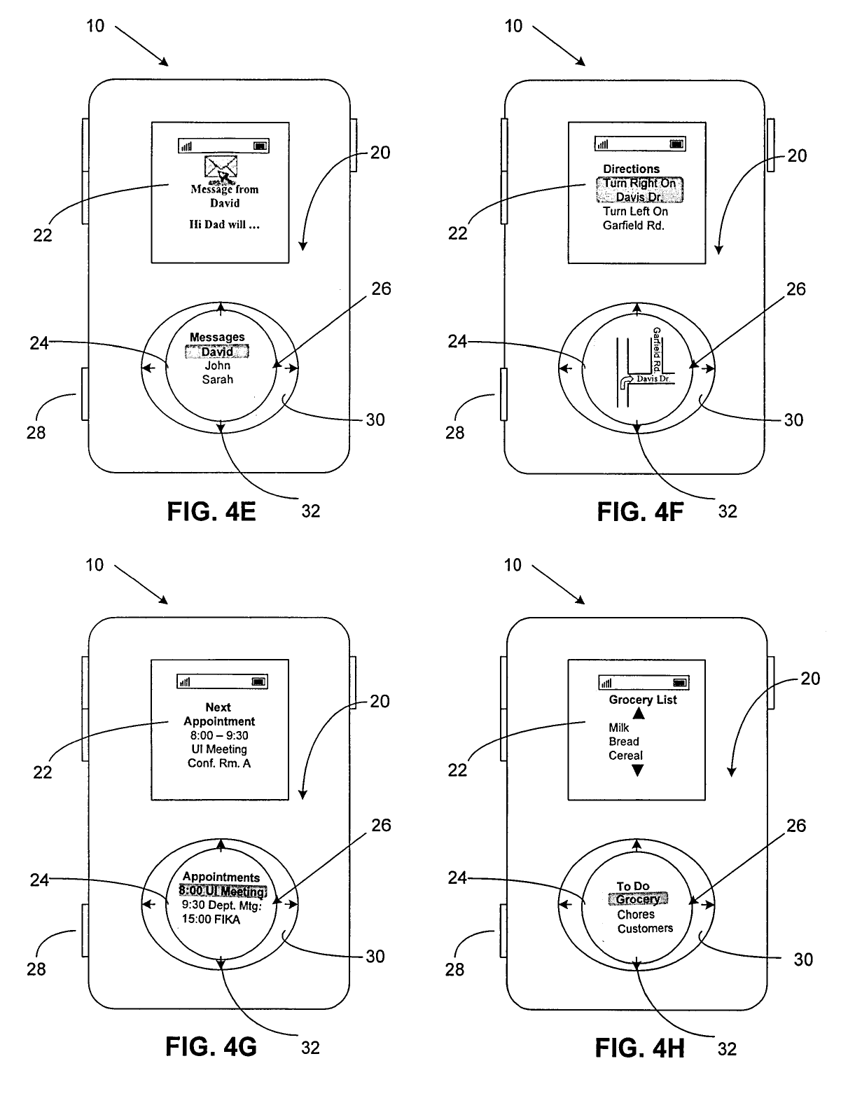

FIGS. 4A-H depict exemplary uses of the display system in connection with various widget categories of related information. As further shown below, within each widget category of related information, sub-displays 22, 24 each display a dataset portion that together constitute a dataset of related information. There may be a series of datasets of related information pertaining to a given selected widget category. In one embodiment, first sub-display 22 may display a general aspect of the related information, and second sub-display 24 may display a more specific aspect of the related information. The five-way touchpad 30 of the navigation mechanism 26 may be used to navigate through either of the sub-displays and select a data item. Upon the selection, the sub-displays may display a new dataset of related information pertaining to the given selected widget category. In this manner, the user may cycle through the datasets within a given widget category.

FIG. 8 depicts generally an exemplary method of displaying information in accordance with the invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention. At step 100, a dataset portion may be displayed on the first sub-display 22. At step 110, another dataset portion may be displayed on the second sub-display 24, wherein the dataset portions together comprise a first dataset of related information. At step 120, a user may navigate through at least one of the dataset portions until a data item is selected at step 130. Once a data item is selected from at least one of the sub-displays, at step 140 the view of at least one of the sub-displays is altered, wherein the sub-displays together display a second dataset of related information.

In addition, as illustrated above, toggle button 28 of the navigation mechanism 26 may be used to move through the different widget categories, each of which has its own series of datasets to be displayed on sub-displays 22, 24. It will be appreciated that other widget categories and associated datasets may be devised without departing from the scope of the invention. It will also be appreciated that other navigation schemes may be devised without departing from the scope of the invention.

Continuing with the examples, FIG. 4A depicts the display system in which a user has selected Time as the widget category from the widget matrix. A first dataset includes in the first sub-display 22 the current time at the user's location (New York in this example), and in the second sub-display 24 the time at a different location (Stockholm in this example). The navigation arrows 32 associated with the second sub-display are part of the navigation mechanism 26. By pressing upon the navigation arrows, a user may select an alternative dataset portion for the second sub-display, which combined with the first sub-display comprises a second dataset within the Time widget. For example, the user may select London time to display with the corresponding New York time as a second dataset. Additional cities, e.g., Tokyo, Moscow, etc. may be selected for displaying additional datasets relating to the Time widget.

Toggle button 28 may be used to toggle to the next widget category. FIG. 4B depicts the display system in which Stereo is the selected widget category. A first dataset may include the current station playing (identified in the first sub-display 22), and a list of preset stations from which the user may select (contained in the second sub-display 24). The navigational mechanism 26 may permit navigation among various radio displays comprising additional datasets within the Stereo widget. For example, by scrolling vertically, a user may select from among specific stations for a given band or grouping, such as an FM group of stations. By scrolling horizontally, a user may select a different band or grouping of stations, such as an AM group, an additional FM group, or others. Each band or group may have its own vertical list of corresponding preset stations from which a user may select. Central button 34 (not shown) may be used to select a particular station, the information about which may then be displayed in the first sub-display 22.

FIG. 4C depicts the display system in which a user has selected Weather as the widget category. A first dataset may include the current weather conditions (first sub-display 22) and precipitation information (second sub-display 24). Again, the user may display additional datasets by employing the navigational arrows. For example, an alternative dataset may contain different historical weather information on the second sub-display, such as recent temperature or pressure trends. In another dataset, the second sub-display may display forecast information for one or more upcoming days.

FIG. 4D depicts the display system in which a user has selected RSS Feed as the widget category. A first dataset may include a selected RSS feed (Google News in the example) along the bottom of the first sub-display 22, and a list of available RSS feeds on the second sub-display 24. Other datasets may include different RSS feeds respectively that are selectable with the navigational arrows and central button. When the user selects an alternative RSS feed, CNN for example, the RSS feed displayed on the first sub-display changes commensurately.

FIG. 4E depicts the display system in which a user has selected Messages as the widget category. A first dataset may include the content of a particular message (first sub-display 22) and a list of other stored messages (second sub-display 24). Additional datasets may contain in the first sub-display content from other messages that may be selected with the navigational arrows and central button.

FIG. 4F depicts the display system in which a user has selected Directions as the widget category. In this example, mobile telephone 10 is equipped with a GPS navigational system, as is known in art, which may provide the user with directions to a particular location. As a first dataset, the first sub-display 22 may display the text directions, and the second sub-display 24 may display a map showing the corresponding location and direction. As additional datasets, the user may scroll vertically through the direction steps in the first sub-display, and the map in the second sub-display may change commensurately. In addition, the user may scroll horizontally to access different sets of directions.

FIG. 4G depicts the display system in which a user has selected Appointments as the widget category. As a first dataset, the first sub-display 22 may display the details regarding a particular appointment, and the second sub-display 24 may display a list of other appointments that are selectable with the navigational arrows and central button. Additional datasets may be displayed as the user selects the different appointments in the second sub-display, in which case the first sub-display changes to display the details of each newly selected appointment commensurately.

FIG. 4H depicts the display system when a user has selected To Do List as the widget category. As a first dataset, details regarding a particular task (grocery for example), may be displayed in the first sub-display 22, and the second sub-display may display additional tasks on the to-do list. As additional datasets, a user may select an alternative task with the navigational arrows and central button in the second sub-display, and the first sub-display would then change commensurately to display details pertaining to each newly selected task.

FIGS. 4A-H represent exemplary content categories for the display system, but a myriad of additional widget categories may be contemplated. For example, the display system of the present invention may be used to access a speaker phone function with the clamshell in the closed position. First sub-display 22 may display a contact list or recent calls list. A user may use the navigation mechanism to scroll through a callers list, with the second sub-display 24 displaying a picture or other information about a particular contact highlighted in the list. When the desired contact is found, the center button may be pressed to initiate a call in speaker phone mode.

As another example, mobile telephones now commonly possess a camera function. The display system may be used in conjunction with the camera function. For example, the first sub-display 22 may display a particular photograph, and the second sub-display 24 may display the next photograph stored in memory. Navigational arrows in the second sub-display may be provided to move through the photographs. Alternatively, the second sub-display may contain a list or thumbnail representation of multiple photographs that are selectable using the navigational arrows and central button. As the user selects particular photographs from the second sub-display in turn, the first sub-display changes to display each newly selected photograph commensurately.

As another example, mobile telephones now commonly possess media player functionality capable of playing audio and/or audiovisual files. If, for example, a user is listening to music, the first sub-display 22 may contain information pertaining to the song playing currently. If watching a video, the video may play in the first sub-display. The second sub-display 24 may contain playlists from which a user may select other media files with the navigational arrows and central button. In one embodiment, the user may navigate horizontally to display alternative playlists and vertically to select the specific media files for a given playlist.

As another example, mobile telephones now commonly are being used as gaming devices. A game may be played in the first sub-display 22, and the second sub-display 24 may display related information such as recent or high scores.

Other widget categories of information and associated datasets may be displayed in a comparable manner without departing from the scope of the invention.

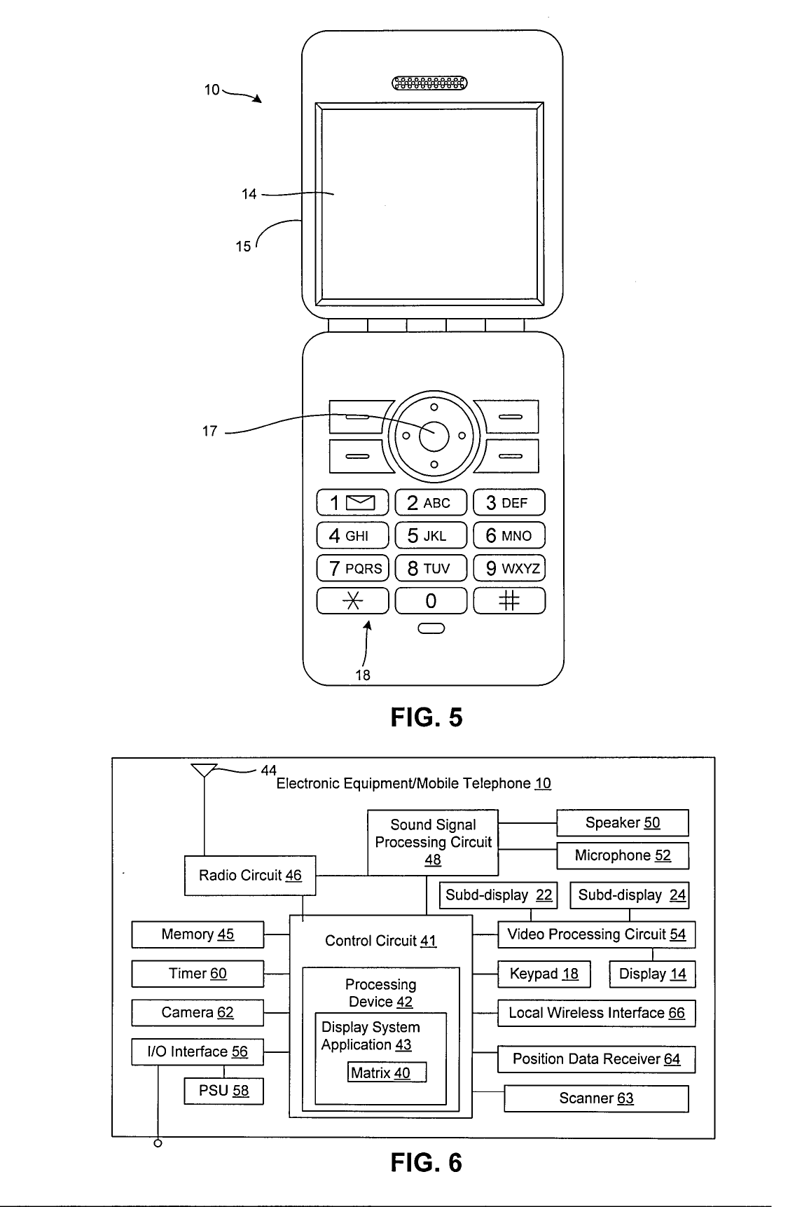

Referring to FIGS. 5 and 6, the features of mobile telephone 10 will now be described. As shown in FIG. 5, mobile telephone 10 may be a clamshell phone with a flip-open cover 15 movable between an open and a closed position. In FIG. 5, the cover is shown in the open position. FIG. 6 represents a functional block diagram of the mobile telephone 10. For the sake of brevity, generally conventional features of the mobile telephone 10 will not be described in great detail herein. The mobile telephone 10 includes a display system application program 43 for carrying out the features of the invention. Application 43 may be embodied as executable code that is resident in and executed by the mobile telephone 10. The mobile telephone 10 may include a controller or processor that executes the program stored on a computer or machine-readable medium. The program may be a stand-alone software application or form a part of a software application that carries out additional tasks related to the mobile telephone 10.

In addition to the external sub-displays 22, 24, mobile telephone 10 may include an internal display 14 viewable when the clamshell telephone is in the open position. The display 14 displays information to a user regarding the various features and operating state of mobile telephone 10, and displays visual content received by the mobile telephone 10 and/or retrieved from a memory 45 (FIG. 4). Also, the display 14 may be used as an electronic viewfinder for a camera assembly 62.

A keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “call send” key for initiating or answering a call, and a “call end” key for ending or “hanging up” a call. Special function keys also may include menu navigation and select keys to facilitate navigating through a menu displayed on the display 14. Some or all of the keys may be used in conjunction with the display as soft keys. Keys or key-like functionality also may be embodied as a touch screen associated with the display 14. When camera assembly 62 is employed, keys from the keypad 18 may be used to control operation of the camera. For instance, one of the keys may serve as a shutter button 17.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for simple message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 includes a primary control circuit 41 that is configured to carry out overall control of the functions and operations of the mobile telephone 10. The control circuit 41 may include a processing device 42, such as a CPU, microcontroller or microprocessor. The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 and sub-displays 22, 24 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method. The mobile telephone 10 also may include a position data receiver 64, such as a global positioning system (GPS) receiver, Galileo satellite system receiver or the like.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the local wireless interface 66 may operatively couple the mobile telephone 10 to a headset assembly (e.g., a PHF device) in an embodiment where the headset assembly has a corresponding wireless interface.

The mobile telephone 10 also may include an I/O interface 56 that permits connection to a variety of I/O conventional I/O devices. One such device is a power charger that can be used to charge an internal power supply unit (PSU) 58.

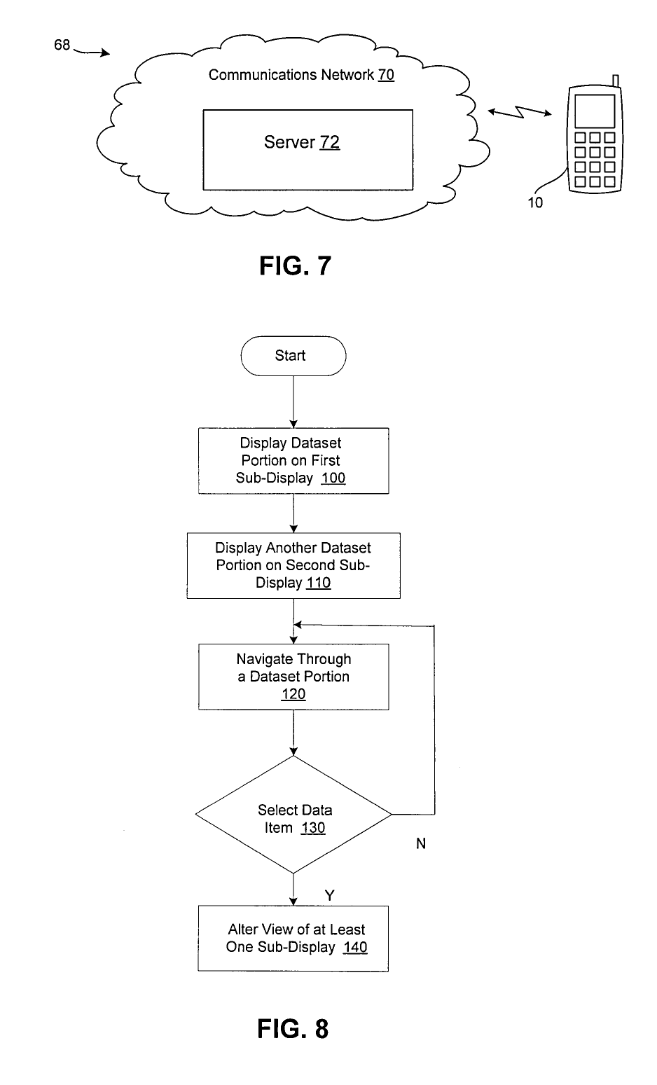

With additional reference to FIG. 7, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Network 70 may provide information displayed in connection with the display system of the present invention. For example, a user may obtain time information, weather information, radio signals, RSS Feeds, etc. via the network 70.

Referring again to FIG. 6, the mobile telephone 10 has a control circuit 41 containing a processing device 42. Among their functions, to implement the features of the present invention, the control circuit 41 and/or processing device 42 comprise a controller that may execute program code embodied as the display system application 43. It will be apparent to a person having ordinary skill in the art of computer programming, and specifically in application programming for cameras, mobile telephones or other electronic devices, how to program a mobile telephone to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device comprising:
a display system having a first sub-display and a second sub-display, wherein the first and second sub-displays together display a first dataset of related information;
a navigation mechanism; and
a controller that is configured to receive an input from the navigation mechanism corresponding to a data selection from at least one of the first or second sub-displays, wherein in response to the input, the controller alters the view of at least one of the first or second sub-displays such that the sub-displays together display a second dataset of related information.

2. An electronic device according to claim 1, wherein the electronic device is a mobile telephone.

3. An electronic device according to claim 2, wherein the mobile telephone is a clamshell mobile telephone with a flip-open cover movable between an open and a closed position, and the first sub-display, second sub-display, and navigation mechanism are located on an external surface of the mobile telephone when the mobile telephone is in the closed position.

4. An electronic device according to claim 1, wherein at least part of the navigation mechanism is integrated with the second sub-display.

5. An electronic device according to claim 1, wherein the navigation mechanism comprises a touchpad.

6. An electronic device according to claim 5, wherein the touchpad is a five-way touchpad comprising four directional touchpad surfaces and a fifth enter button.

7. An electronic device according to claim 5, wherein the navigation mechanism further comprises a toggle button.

8. An electronic device according to claim 7, wherein the related information is a first category of information, and the controller is further configured to receive an input from the toggle button and in response to the toggle button input, the controller alters the view of at least one of the first or second sub-displays such that the sub-displays together display a dataset relating to a second category of information.

9. An electronic device according to claim 1, wherein the related information is defined by a matrix stored in a memory within the electronic device, and wherein the matrix is displayed on at least one of the first or second sub-displays.

10. An electronic device according to claim 1, wherein the first sub-display displays a general aspect of the related information and the second sub-display displays a specific aspect of the related information.

11. A display system for use in an electronic device comprising:
a first sub-display;
a second sub-display in signal communication with the first sub-display, wherein the first and second sub-displays together display a first dataset of related information; and
a navigation mechanism configured to make a data selection from at least one of the first or second sub-displays;
wherein a selection with the navigation mechanism from at least one of the first or second sub-displays alters the view of at least one of the first or second sub-displays, such that the first and second sub-displays together display a second dataset of related information.

12. A display system accordingly to claim 11, wherein at least part of the navigation mechanism is integrated with the second sub-display.

13. A display system according to claim 11, wherein the navigation mechanism comprises a touchpad.

14. A display system according to claim 13, wherein the touchpad is a five-way touchpad comprising four directional touchpad surfaces and a fifth enter button.

13. A display system according to claim 13, wherein the navigation mechanism further comprises a toggle button.

14. A display system according to claim 11, wherein the related information is defined by a matrix displayed on at least one of the first or second sub-displays.

15. A display system according to claim 11, wherein the first sub-display displays a general aspect of the related information and the second sub-display displays a specific aspect of the related information.

16. A method of displaying information on an electronic device comprising the steps of:
displaying a dataset portion on a first sub-display;
displaying another dataset portion on a second sub-display wherein the dataset portions together comprise a first dataset of related information;
navigating through at least one of the dataset portions on at least one of the first or second sub-displays;
selecting a data item from at least one of the dataset portions on at least one off the first or second sub-displays; and
altering the view displayed on at least one of the first or second sub-displays in response to the selection such that the sub-displays together display a second dataset of related information.

17. A method of displaying information on an electronic device according to claim 16, wherein the related information is a first category of information, and further comprising:
toggling the first and second sub-displays such that the sub-displays together display a dataset relating to a second category of information.

18. A method of displaying information on an electronic device according to claim 16, wherein the related information is a first category of information, and further comprising:
navigating through an information matrix of data items displayed on at least one of the first or second sub-displays;
selecting a data item from the matrix; and
altering at least one of the first or second sub-displays such that the sub-displays together display a dataset relating to a second category of information.
